(19) United States
(12) Patent Application Publication
(10) Pub. No.: US 2025/0256686 A1
(43) Pub. Date: Aug. 14, 2025

(54) AUTOMOTIVE DETAILING MAT AND METHODS FOR PROTECTING A SURFACE

(71) Applicant: Daniel Squires, Amherst, OH (US)

(72) Inventor: Daniel Squires, Amherst, OH (US)

(21) Appl. No.: 19/042,664

(22) Filed: Jan. 31, 2025

Related U.S. Application Data
(60) Provisional application No. 63/551,248, filed on Feb. 8, 2024.

(51) Int. Cl. B60S 3/04

(52) U.S. Cl. CPC B60S 3/042

(57) ABSTRACT

An automotive detailing mat and method of protecting a surface during the detailing of an automotive wheel and tire assembly, the automotive detailing mat including a planar body having a thickness, a first major surface opposite a second major surface, and a plurality of edges, and wherein the plurality of edges comprises a first edge defining a U-shaped recess in the planar body disposed at a first line of symmetry perpendicular to the first edge, and wherein the method includes positioning the automotive detailing mat around the automotive wheel and tire assembly such that the U-shaped recess of the automotive detailing mat is adjacent to and abuts the portion of the automotive wheel and tire assembly forming the contact patch to thereby form a seal between the automotive wheel and tire assembly and the automotive detailing mat.

### CROSS-REFERENCE TO RELATED APPLICATIONS

The present application claims the benefit of U.S. Provisional Patent Application No. 63/551,248, filed on Feb. 8, 2024, which is incorporated herein in its entirety.

### FIELD OF THE INVENTION

The present invention generally relates to a mat that may be placed on the floor around a tire that is resting on the ground. The present invention specifically relates to a mat for protecting the floor around the tire from damage due to overspray of a spray conditioner applied to a tire or wheel. A method for protecting the floor around the tire while the tire is being treated by a spray conditioner is also disclosed.

### BACKGROUND OF THE INVENTION

Vehicles are an essential part of everyday life. Vehicle owners want to maintain the condition of their vehicles in order to prolong the use of the vehicle, and make their cars appear as if they are new. One way vehicles are maintained is to have the tires conditioned to extend the life of the rubber in the tire. Those in the business of car detailing utilize tire treatment solution sprays, which is sprayed onto the tire while the tire is on the ground and it can be hard to only get the tire treatment solution on the tire and not on the ground. These tire treatment solutions can stain and damage the floor where the spray may unintentionally land. Other businesses that specialize in detailing cars, so that cars appear clean and new, may need to use other staining tire treatment solutions while cleaning the tires of the vehicle.

Additionally, while servicing vehicles service technicians may need to place such items as rags, containers of cleaning tire treatment solution, or other items used to detail a tire nearby. So that items are nearby service technicians may place the items directly on the ground by the tire while servicing the tire. By placing these items on the ground, the ground may become stained or damaged.

Further, the ground where a service technician is working may contain loose debris or particles. These loose debris and particles could prevent a thorough detailing or conditioning job. Loose debris and particles could get on the rags or items used to detail the vehicle, which could scratch the vehicle.

Service technicians have utilized mats that may be placed next to the tire in an effort to protect the ground by providing a place to set tools or rags. These mats, however, do not protect the ground underneath the tread of the tire. If service technicians wanted to cover the whole area around the tire they may use multiple mats, which could cause gaps or overlap where tire treatment solution could spread to the ground. Additionally, service technicians could lay out a mat and then drive the vehicle onto the mat, however, that could damage the mat over time or not provide a proper placement where the entire area under the tire is covered. Therefore, there is a need in the art for a mat that can surround the tire while the tire sits on the ground that can easily be inserted and removed.

### SUMMARY OF THE INVENTION

At least one embodiment of the present invention provides an automotive detailing mat including a planar body having a thickness, a first major surface opposite a second major surface, and a plurality of edges and wherein the plurality of edges comprises a first edge defining a U-shaped recess in the planar body disposed at a first line of symmetry perpendicular to the first edge.

Another embodiment of the present invention provides an automotive detailing mat as in any embodiment above, wherein the planar body comprises an aperture disposed on the first line of symmetry spaced apart from the U-shaped recess.

Still another embodiment of the present invention provides an automotive detailing mat as in any embodiment above, wherein the planar body comprises a rectangular shape including a second edge parallel to the first edge and connected to the first edge by a third edge and a fourth edge, wherein the third and fourth edges are parallel to the first line of symmetry.

Yet another embodiment of the present invention provides an automotive detailing mat as in any embodiment above, wherein the second edge has a length of 24 inches or greater.

Still another embodiment of the present invention provides an automotive detailing mat as in any embodiment above, wherein the third and fourth edges have a length of 16 inches or greater.

Another embodiment of the present invention provides an automotive detailing mat as in any embodiment above, wherein the second edge has a length of 24 inches or greater, and wherein the third and fourth edges have a length of 16 inches or greater.

Still another embodiment of the present invention provides an automotive detailing mat as in any embodiment above, wherein the aperture is disposed 2 inches or more from the second edge; wherein the aperture is a circular hole with a diameter of 1.50 inches or greater; and wherein the aperture further comprises a reinforcing grommet including a hole with a diameter of 1.25 inches or greater.

Yet another embodiment of the present invention provides an automotive detailing mat as in any embodiment above, wherein the U-shaped cutout comprises a parallel pair of linear edge portions spaced apart equidistantly from the first line of symmetry, the parallel pair of linear edge portions connected by an arcuate edge portion centered on the first line of symmetry.

Another embodiment of the present invention provides an automotive detailing mat as in any embodiment above, wherein the parallel pair of linear edge portions each have a length of 3 inches or greater.

Still another embodiment of the present invention provides an automotive detailing mat as in any embodiment above, wherein the arcuate edge portion has a minimum radius of 3 inches or greater.

Yet another embodiment of the present invention provides an automotive detailing mat as in any embodiment above, wherein the parallel pair of linear edge portions each have a length of 3 inches or greater, and wherein the arcuate edge portion has a minimum radius of 3 inches or greater.

Another further comprising the step of storing the automotive detailing mat by hanging the automotive detailing mat using the aperture, wherein the planar body comprises a rectangular shape including a second edge parallel to the first edge and connected to the first edge by a third edge and a fourth edge, wherein the third and fourth edges are parallel to the first line of symmetry, wherein the second edge has a length of 24 inches or greater, wherein the third and fourth edges have a length of 16 inches or greater, wherein the U-shaped cutout comprises a parallel pair of linear edge portions spaced apart equidistantly from the first line of symmetry, the parallel pair of linear edge portions connected by an arcuate edge portion centered on the first line of symmetry,

A further embodiment of the present invention provides a method of protecting a surface during the detailing of an automotive wheel and tire assembly, the method including providing the automotive wheel and tire assembly such that a contact patch of the automotive wheel and tire assembly is contacting the surface, providing an automotive detailing mat as in any embodiment described above, positioning the automotive detailing mat around the automotive wheel and tire assembly such that the U-shaped recess of the automotive detailing mat is adjacent to and abuts the portion of the automotive wheel and tire assembly forming the contact patch to thereby form a seal between the automotive wheel and tire assembly and the automotive detailing mat, detailing the automotive wheel and tire assembly, and detailing the automotive wheel and tire assembly, wherein the parallel pair of linear edge portions each have a length of 3 inches or greater, and wherein the arcuate edge portion has a minimum radius of 3 inches or greater.

Another embodiment of the present invention provides a method of protecting a surface during the detailing of an automotive wheel and tire assembly as in any embodiment above, further comprising the step of removing contaminants from the automotive detailing mat resulting from the step of detailing the automotive wheel and tire assembly.

Still another embodiment of the present invention provides a method of protecting a surface during the detailing of an automotive wheel and tire assembly as in any embodiment above, wherein the automotive detailing mat further comprises an aperture disposed on the first line of symmetry spaced apart from the U-shaped recess; wherein the step of positioning includes positioning the automotive detailing mat around the automotive wheel and tire assembly using the aperture; and wherein the step of removing includes removing the automotive detailing mat using the aperture.

Yet another embodiment of the present invention provides a method of protecting a surface during the detailing of an automotive wheel and tire assembly as in any embodiment above, further comprising the step of storing the automotive detailing mat by hanging the automotive detailing mat using the aperture.

### BRIEF DESCRIPTION OF THE DRAWINGS

These and other features and advantages of the present invention will become better understood with regard to the following description, appended claims, and accompanying drawings wherein:

FIG. 1 is a representation of a mat according to the concepts of the present invention; and

FIG. 2. is a representation of the mat according to FIG. 1 used in combination with a tire of an automobile or other vehicle, wherein the mat is placed on the floor adjacent to and abutting the perimeter of the tire touching the ground.

### DETAILED DESCRIPTION OF ILLUSTRATIVE EMBODIMENTS

### Introduction

Embodiments of the present invention are based, at least in part, on the discovery of an automotive detailing mat having a U-shaped recess formed therein for protecting a surface while detailing an automotive wheel and tire assembly. In some embodiments, the U-shaped recess is advantageously shaped and sized to surround a contact patch of the automotive wheel and tire assembly to thereby form a seal between the automotive wheel and tire assembly and automotive detailing mat such that the surface covered by the automotive detailing mat is protected from spray conditioners and other contaminants that may fall to the ground while detailing the automotive wheel and tire assembly. In this and other embodiments, the automotive detailing mat is readily positioned at the automotive wheel and tire assembly such that each wheel and tire assembly may be detailed without needing to move the vehicle. Notably, the use of the automotive detailing mat having a U-shaped recess protects the surface from contamination, which is particularly desirable when the detailing is being performed at the vehicle owner's property, where discoloration and other damage to the surface such as a garage floor or driveway would be highly undesirable.

### Automotive Detailing Mat

Embodiments of automotive detailing mats according to the present invention generally comprise a planar body having a thickness, a first major surface opposite a second major surface, and a plurality of edges, wherein the plurality of edges comprises a first edge defining a U-shaped recess in the planar body disposed at a first line of symmetry perpendicular to the first edge. In these and other embodiments, the planar body comprises an aperture disposed on the first line of symmetry spaced apart from the U-shaped recess. In further embodiments, the U-shaped cutout comprises a parallel pair of linear edge portions spaced apart equidistantly from the first line of symmetry, the parallel pair of linear edge portions connected by an arcuate edge portion centered on the first line of symmetry.

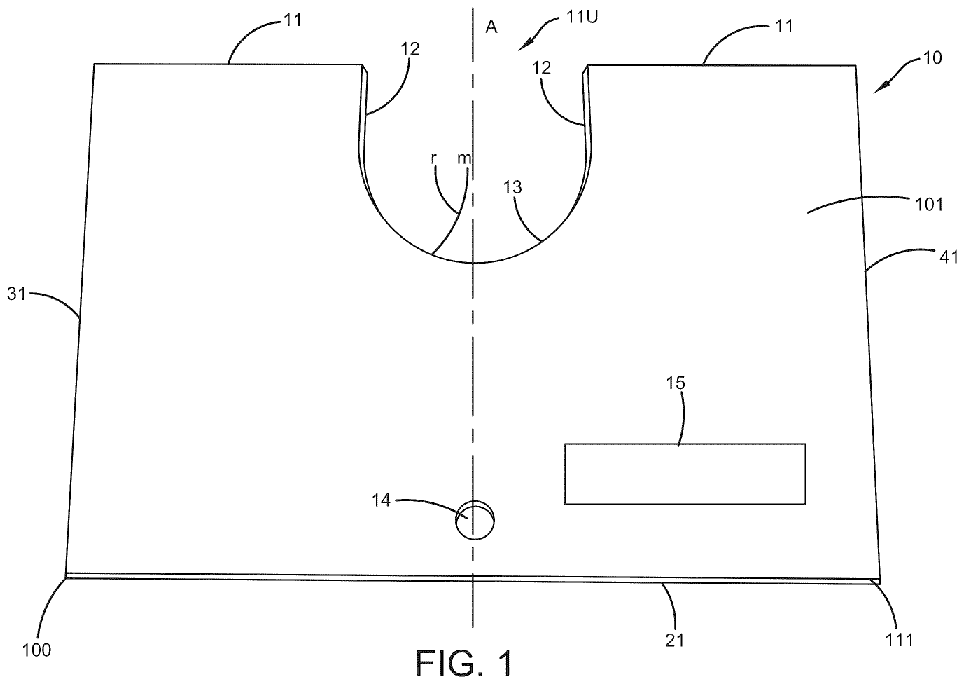

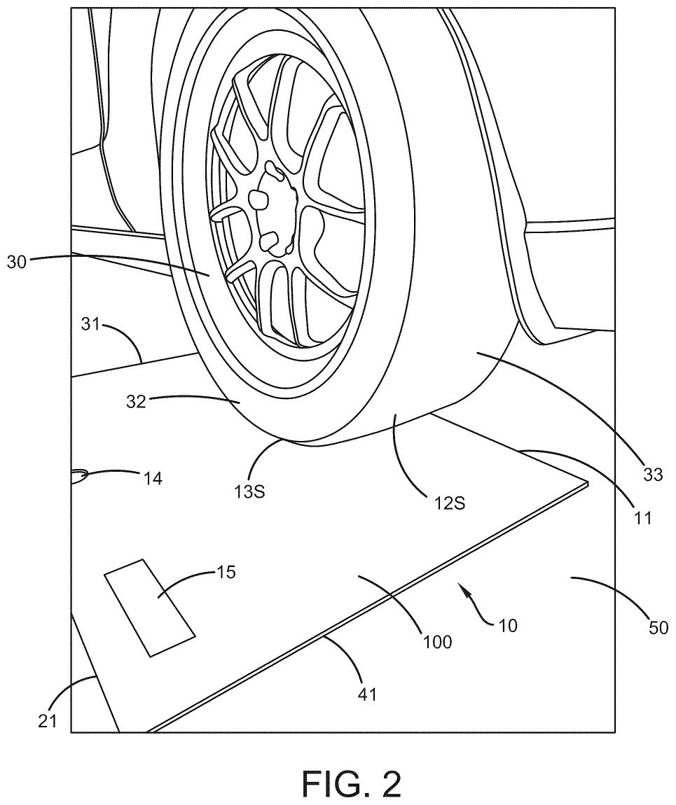

As shown in FIGS. 1 and 2, an illustrative embodiment of an automotive detailing mat 10 according to the present invention includes a planar body 100 having a thickness 111 and a first major surface 101 opposite a second major surface (not shown), and a plurality of edges 11, 21, 31, 41 including a first edge 11 which further includes a U-shaped recess 11U. U-shaped recess 11U is disposed at a first line of symmetry A, which is perpendicular to first edge 11. U-shaped recess 11U includes a parallel pair of linear edge portions 12 spaced apart, equidistantly, from first line of symmetry A, the parallel pair of linear edge portions 12 are connected by an arcuate edge portion 13 centered on first line of symmetry A. Automotive detailing mat 10 further has an aperture 14 extending from first major surface 101 through thickness 111 of planar body 100 to the second major surface. Aperture 14 is formed along first line of symmetry A. Without wishing to be bound by theory, forming aperture 14 along first line of symmetry A provides improved control when positioning automotive detailing mat 10 around a wheel and tire assembly. Automotive detailing mat 10 further includes indicia 15. Indicia 15 may include branding information as well as sizing information for listing the size of wheels and tires automotive detailing mat 10 is compatible with and may be located in a variety of locations on automotive detailing mat 10.

As shown in FIGS. 1 and 2, aperture 14 is a circular hole. In other embodiments, aperture 14 may have a different shape. In these and other embodiments, aperture 14 may be reinforced such as through the placement of a reinforcing grommet. Reinforcing aperture 14 advantageously protects it during use of automotive detailing mat 10 as well as when storing automotive detailing mat 10, such as hanging automotive detailing mat 10 from a hook contacting aperture 14. During use aperture 14 is finger manipulable and therefore is sized accordingly. In one or more embodiments, apertures according to the present invention with and without reinforcement have a minimum hole diameter of 1.25 inches or greater, in other embodiments 1.50 inches or greater, in other embodiments 1.75 inches or greater, and in other embodiments 2.00 inches or greater.

In some embodiments, the size of U-shaped recess 11U is varied to accommodate different tire sizes. The person of ordinary skill in the art understands that the lengths of the parallel pair of linear edge portions 12 may have a length. Likewise, the person of ordinary skill in the art understands that arcuate edge portion 13 may have a minimum radius, r, as measured from a point, m, located on first line of symmetry A at the length of parallel portions 12 from first edge 11. It is understood that tire contact patches have a roughly rectangular shape with rounded edges or an elliptical shape, with the shape varying depending upon a number of factors including tire size, tire pressure, vehicle weight, and tire profile, amongst others. Accordingly, the person of ordinary skill in the art understands that the shape of U-shaped recess 11U may be adjusted to accommodate different contact patch geometries so that a quality seal may be formed where automotive detailing mat 10 abuts the wheel and tire assembly. In one or more embodiments, the opposing pair of parallel edge portions 12 may have a length of 3 inches or greater, in other embodiments 4 inches or greater, in other embodiments 5 inches or greater, in other embodiments, 6 inches or greater, in other embodiments 7 inches or greater, in other embodiments 8 inches or greater, in other embodiments 9 inches or greater, in other embodiments 10 inches or greater, in other embodiments 15 inches or greater, and in other embodiments 20 inches or greater. It is appreciated that the radius as measured at one point along arcuate edge portion 13 may be different from another point and that the minimum reflects the radius as measured from the point on arcuate edge portion 13 to the point on first line of symmetry A at the length of parallel portions 12 from first edge 11. In these and other embodiments, arcuate edge portion 13 may have a minimum radius as measured from a point located on first line of symmetry A at the length of parallel portions 12 from first edge 11 of 3 inches or greater, in other embodiments 4 inches or greater, in other embodiments 5 inches or greater, in other embodiments, 6 inches or greater, in other embodiments 7 inches or greater, in other embodiments 8 inches or greater, in other embodiments 9 inches or greater, and in other embodiments 10 inches or greater.

The person of ordinary skill in the art appreciates that automotive detailing mats according to the present invention may include a variety of geometries and any number of edges. As shown in FIG. 1, automotive detailing mat 10 has a generally rectangular geometry where first side 11 and second side 21 are parallel to each other and form relatively long sides to third side 31 and fourth side 41, which are parallel to each other. In one or more embodiments first side and second sides of the present invention have a length of 24 inches or greater, in other embodiments 30 inches or greater, in other embodiments 36 inches or greater, in other embodiments 42 inches or greater, and in other embodiments 48 inches or greater. In these and other embodiments, third and fourth sides of the present invention have a length of 12 inches or greater, in other embodiments 16 inches or greater, in other embodiments 20 inches or greater, in other embodiments 24 inches or greater, in other embodiments 28 inches or greater, in other embodiments 32 inches or greater, and in other embodiments 36 inches or greater.

In one or more embodiments, automotive detailing mats have a thickness of 0.0625 inches or greater, in other embodiments 0.125 inches or greater, in other embodiments 0.25 inches or greater, and in other embodiments 0.50 inches or greater.

In one or more embodiments, first major surfaces of automotive detailing mats according to the present invention have a smooth surface. In other embodiments, first major surfaces of automotive detailing mats according to the present invention have a smooth surface have a contoured surface such that liquids may be contained within the first major surface. In these and other embodiments, the plurality of edges may be raised such that a volume defined by the height of the raised plurality of edges and the first major planar surface is formed. Such embodiments advantageously allow for the collection of fluids used while detailing an automotive wheel and tire assembly.

In one or more embodiments, automotive detailing mats comprise one or more chemically resistant materials. Suitable materials for forming automotive detailing mats according to the present invention include ABS plastic, rubber, vinyl, polymer and recycled materials, amongst others. Suitable materials may include those that are pliable or non-pliable. Likewise suitable materials may be porous or non-porous. Techniques known for processing the above described materials may be used to form embodiments of automotive detailing mats including calendaring and then cutting to the desired size and shapes. Other techniques may include stamping a sheet of material into the desired size and shape.

### Methods of Protecting a Surface

As discussed in the background of the invention, there is a need to protect the surfaces that vehicles are parked on when detailing an automotive wheel and tire assembly, especially if the detailing is being performed in the driveway or garage of the vehicle's owner as opposed to a shop environment. Accordingly, embodiments of the present invention provide methods for protecting a surface during the detailing of an automotive wheel and tire assembly.

In one or more embodiments, methods of protecting a surface according to present invention include providing an automotive wheel and tire assembly that includes a contact patch where the automotive wheel and tire assembly contacts the surface, providing an automotive detailing mat as described in embodiment above, positioning the automotive detailing mat around the automotive wheel and tire assembly such that the U-shaped recess of the automotive detailing mat is adjacent to and abutting the portion of the automotive wheel and tire assembly forming the contact patch to thereby form a seal where the automotive detailing mat abuts the automotive wheel and tire assembly, detailing the automotive wheel and tire assembly, and removing the automotive detailing mat. In one or more embodiments, the step of positioning includes positioning the automotive detailing mat around the automotive wheel and tire assembly using the aperture; and wherein the step of removing includes removing the automotive detailing mat using the aperture.

In one or more embodiments, methods of protecting a surface according to present invention further include removing contaminants from the automotive detailing mat resulting from the step of detailing the automotive wheel and tire assembly.

In one or more embodiments, methods of protecting a surface according to present invention further include the step of storing the automotive detailing mat by hanging the automotive detailing mat using the aperture.

As shown in FIG. 2. automotive detailing mat 10 has been positioned to form a seal 12S, 13S to protect surface 50 while detailing automotive wheel and tire assembly 30. Seal 12S, 13S includes the interface of U-shaped recess 11U including parallel edge portions 12 contacting and abutting tire tread 33 at the contact patch of automotive wheel and tire assembly 30, and arcuate edge portion 13 contacting and abutting tire sidewall 32 at the contact patch of automotive wheel and tire assembly 30. One can readily appreciate the overspray from detailing chemicals, water, dirt, debris, and other contaminants will readily fall onto first major surface 101 of automotive detailing mat 10 which thereby protects surface 50 from contamination. Additionally, automotive detailing mat 10 provides a clean and dry surface on which detailing tools such as chamois, brushes, polishing pads, towels, and others may be placed to avoid becoming wet or otherwise contaminated from surface 50 which may be wet and soapy from washing of the vehicle prior to detailing automotive wheel and tire assembly 30. Upon completion of the detailing of automotive wheel and tire assembly 30, automotive detailing mat 10 may be removed by manipulating aperture 14 to slide the mat from around automotive wheel and tire assembly 30.

Various modifications and alterations that do not depart from the scope and spirit of this invention will become apparent to those skilled in the art. This invention is not to be duly limited to the illustrative embodiments set forth herein.

What is claimed is:

1. An automotive detailing mat comprising:
a planar body having a thickness, a first major surface opposite a second major surface, and a plurality of edges; and
wherein the plurality of edges comprises a first edge defining a U-shaped recess in the planar body disposed at a first line of symmetry perpendicular to the first edge.

2. The automotive detailing mat of claim 1, wherein the planar body comprises an aperture disposed on the first line of symmetry spaced apart from the U-shaped recess.

3. The automotive detailing mat of claim 2, wherein the planar body comprises a rectangular shape including a second edge parallel to the first edge and connected to the first edge by a third edge and a fourth edge, wherein the third and fourth edges are parallel to the first line of symmetry.

4. The automotive detailing mat of claim 3, wherein the second edge has a length of 24 inches or greater.

5. The automotive detailing mat of claim 3, wherein the third and fourth edges have a length of 16 inches or greater.

6. The automotive detailing mat of claim 3, wherein the aperture is disposed 2 inches or more from the second edge; wherein the aperture is a circular hole with a diameter of 1.50 inches or greater; and wherein the aperture further comprises a reinforcing grommet including a hole with a diameter of 1.25 inches or greater.

7. The automotive detailing mat of claim 1, wherein the U-shaped cutout comprises a parallel pair of linear edge portions spaced apart equidistantly from the first line of symmetry, the parallel pair of linear edge portions connected by an arcuate edge portion centered on the first line of symmetry.

8. The automotive detailing mat of claim 7, wherein the parallel pair of linear edge portions each have a length of 3 inches or greater.

9. The automotive detailing mat of claim 7, wherein the arcuate edge portion has a minimum radius of 3 inches or greater.

10. A method of protecting a surface during the detailing of an automotive wheel and tire assembly, the method comprising:
providing the automotive wheel and tire assembly such that a contact patch of the automotive wheel and tire assembly is contacting the surface;
providing the automotive detailing mat of claim 1;
positioning the automotive detailing mat around the automotive wheel and tire assembly such that the U-shaped recess of the automotive detailing mat is adjacent to and abuts the portion of the automotive wheel and tire assembly forming the contact patch to thereby form a seal between the automotive wheel and tire assembly and the automotive detailing mat;
detailing the automotive wheel and tire assembly; and
removing the automotive detailing mat.

11. The method of protecting a surface according to claim 10, further comprising the step of removing contaminants from the automotive detailing mat resulting from the step of detailing the automotive wheel and tire assembly.

12. The method of protecting a surface according to claim 10, wherein the automotive detailing mat further comprises an aperture disposed on the first line of symmetry spaced apart from the U-shaped recess; wherein the step of positioning includes positioning the automotive detailing mat around the automotive wheel and tire assembly using the aperture; and wherein the step of removing includes removing the automotive detailing mat using the aperture.

13. The method of protecting a surface according to claim 12, further comprising the step of storing the automotive detailing mat by hanging the automotive detailing mat using the aperture.
